(19) United States
(12) Patent Application Publication
(10) Pub. No.: US 2025/0260472 A1
(43) Pub. Date: Aug. 14, 2025

(54) SELECTION AND VALIDATION OF BEAM SUBSETS

(71) Applicant: Telefonaktiebolaget LM Ericsson (publ), Stockholm (SE)

(72) Inventors: Nic Ekman, Lund (SE); Ilias Theodoros Skordas, Lund (SE); Marcus Davidsson, Lund (SE); Filip Johansson, Malmö (SE); Markus Ernstsson, Lund (SE)

(21) Appl. No.: 18/856,402

(22) PCT Filed: Apr. 12, 2023
(86) PCT No.: PCT/EP2023/059533

§ 371 Date: Oct. 11, 2024

(30) Foreign Application Priority Data
Apr. 14, 2022 (GR) 20220100324

(51) Int. Cl. H04B 7/08; H04B 7/06; H04W 24/08

(52) U.S. Cl. CPC H04B 7/088; H04B 7/0695; H04W 24/08

(57) ABSTRACT

Systems and methods are disclosed for beam subset selection and validation. In one embodiment, a method performed by a network node for a wireless network that utilizes transmit and/or receive beamforming comprises dynamically selecting a subset of beams for a particular wireless communication device, the subset of beams being a subset of a set of available beams. In one embodiment, dynamically selecting the subset of beams for the particular wireless communication device comprises dynamically selecting which of the set of available beams are included in the subset of beams for the particular wireless communication device. The method further comprises performing one or more actions based on the selected subset of beams. Compared to a static beam subset implementation, this dynamic beam subset selection procedure provides improved results with respect to beam misses.

### RELATED APPLICATIONS

This application claims the benefit of Greek patent application serial number 20220100324, filed Apr. 14, 2022, the disclosure of which is hereby incorporated herein by reference in its entirety.

### TECHNICAL FIELD

The present disclosure relates to a wireless communication system that utilizes transmit and/or receive beamforming.

### BACKGROUND

The advancements in today's technology have motivated the development of faster mobile communication systems. The Fifth-Generation (5G) mobile network is the latest mobile communication system made by the Third-Generation Partnership Project (3GPP) and expects to both increase connection speed and reduce latency, which eventually will make it applicable to support state-of-the art technologies such as, e.g., virtual reality (VR), self-driving vehicles, and remote surgery at hospitals.

In a 5G system, management of the physical channels used for communication between New Radio (NR) base station (gNB) and User Equipment (UE) is an important task to optimize utilization of available resources. These available resources include time resources (e.g., slots), frequency resources (e.g., subcarriers), spatial resources (e.g., beams or spatial resources introduced via beamforming). In millimeter wave (mmW) frequencies, the physical channels are emitted from the gNB in the form of wide beams organized in a grid pattern around the cell tower, each containing a number of narrow beams. As the UE moves around the area covered by the gNB, the UE will continuously perform Reference Signal Received Power (RSRP) measurements on Synchronization Signal Blocks (SSBs) transmitted over each of the widebeams. However, due to constraints posed by the system architecture, only a limited number of the strongest beam indexes (e.g., 4) will be transmitted back to the gNB to be used in beam management.

Again, due to limitations in the system architecture, namely device memory or processing limitations for example in handling of beam specific Tracking Reference Signals (TRS) on the UE side, the current implementation utilizes overlapping, hard-coded, static subsets of the grid layout made up from the widebeam arrangement. At a given point in time, the UE will be assigned one such subset defining the set of beams where the UE can be provided full access (i.e., a set of candidate beams that can be used for communication with the UE). In order to make optimal use of available resources, meaning to always transfer information over the channel with the strongest signal, the goal of subset assignment is to keep the UE in the subset which contains the best beam. The current static subset layout is based on the theoretical grid created around the gNB in an optimal environment not affected by reflections and shadowing.

The system described above is a distributed system where information is shared over the air interface between components at a cost each time it's updated, i.e., whenever a subset is updated, it comes at a cost of a Radio Resource Control (RRC) message (time, bandwidth, energy) from the gNB to the UE. This system distribution will be the main use case described in the present disclosure, but it should be mentioned that the inventors also see great potential for systems where updating the state is cheap, for example in a digital receiver. The proposed solution(s) described herein can be applied to all kinds of beams, not only widebeams—for example in digital beamforming where beams are not discretely defined but infinitely adjustable angle wise.

### SUMMARY

Systems and methods are disclosed for beam subset selection and validation. In one embodiment, a method performed by a network node for a wireless network that utilizes transmit and/or receive beamforming comprises dynamically selecting a subset of beams for a particular wireless communication device, the subset of beams being a subset of a set of available beams. In one embodiment, dynamically selecting the subset of beams for the particular wireless communication device comprises dynamically selecting which of the set of available beams are included in the subset of beams for the particular wireless communication device. The method further comprises performing one or more actions based on the selected subset of beams. Compared to a static beam subset implementation, this dynamic beam subset selection procedure provides improved results with respect to beam misses, which translates directly to better optimization of how available resources are used, possibly improving metrics such as average Reference Signal Received Power (RSRP), throughput, availability, and reliability.

In one embodiment, performing the one or more actions comprise: (a) sending, to the particular wireless communication device, information that indicates the subset of beams; (b) monitoring for transmissions from the particular wireless communication device on the subset of beams; (c) performing one or more measurements on the subset of beams at the network node; (d) receiving measurements about beams in the subset of beams from the particular wireless communication device; or (e) a combination of any two or more of (a)-(d).

In one embodiment, dynamically selecting the subset of beams for the particular wireless communication device comprises dynamically selecting the subset of beams for the particular wireless communication device based on a current serving beam of the particular wireless communication device.

In one embodiment, dynamically selecting the subset of beams for the particular wireless communication device is further based on one or more additional criteria. In one embodiment, the one or more additional criteria comprise one or more previous serving beams of the particular wireless communication device, one or more beam measurements, or both.

In one embodiment, dynamically selecting the subset of beams for the particular wireless communication device comprises dynamically selecting the subset of beams for the particular wireless communication device based on information that models or represents probabilities that the particular wireless communication device will switch from a current serving beam to each other beam in the set of available beams. In one embodiment, the information that models or represents the probabilities that the particular wireless communication device will switch from the current serving beam to each other beam in the set of available beams is a trained machine learning model. In another embodiment, the information that models or represents the probabilities that the particular wireless communication device will switch from the current serving beam to each other beam in the set of available beams is a beam switch probability matrix or transition matrix. In one embodiment, the information that models or represents the probability that the particular wireless communication device will switch from the current serving beam to each other beam in the set of available beams is a Markov Chain stochastic model, or graph. In one embodiment, dynamically selecting the subset of beams for the particular wireless communication device comprises dynamically selecting a size of the subset of beams based on the probabilities.

In one embodiment, dynamically selecting the subset of beams for the particular wireless communication device comprises dynamically selecting a size of the subset of beams. In this manner, metrics such as average RSRP, throughput, availability, and reliability can be further improved. In addition, energy consumption of the system as whole may be lowered by reducing the average size of the subsets of beams selected and used.

In one embodiment, performing the one or more actions comprises receiving, from the wireless communication device, one or more measurements for at least one beam in the set of available beams or one or more measurements for at least one beam in the subset of beams, and the method further comprises evaluating (also referred to herein as “validating”) the subset of beams based on the one or more measurements for the at least one beam in the set of available beams or the one or more measurements for the at least one beam in the subset of beams. In this manner, a result of the evaluating may be used to adjust or update the dynamic beam subset selection (e.g., during deployment) to provide improved performance.

In one embodiment, evaluating the subset of beams comprises determining whether the subset of beams comprises a best beam from among the set of available beams for the particular wireless communication device, based on the one or more measurements for the at least one beam in the set of available beams or the one or more measurements for the at least one beam in the subset of beams. In one embodiment, the best beam for the particular wireless communication device is one of the set of available beams for which the particular wireless communication device has or is predicted to have a highest received power, a highest reference signal received power, a highest reference signal received quality, a highest signal to noise ratio, a highest signal to interference plus noise ratio, a highest received strength of signal, a highest code rate, a lowest block error rate, a highest channel quality, highest throughput, a lowest amount of associated control signaling, or a lowest probability of triggering a change in the subset of beams.

In one embodiment, evaluating the subset of beams comprise evaluating the subset of beams based on the one or more measurements for the at least one beam in the subset of beams, and a machine learning model. In one embodiment, the machine learning model predicts a best beam for the wireless communication device from among the set of available beams based on the one or more measurements for the at least one beam in the subset of beams.

In one embodiment, the method further comprises, adjusting one or more parameters related to selection of a subset of beams based on the evaluating and selecting a new subset of beams for the particular wireless communication device based on the one or more adjusted parameters. In one embodiment, the one or more adjusted parameters comprise a parameter related to a number of beams included in the new subset of beams, a parameter related to a number of beams needed in the subset of beams to satisfy a predefined or configured accuracy related to a mishit of a best beam from the set of available beams for the particular wireless communication device being within the subset of beams, one or more parameters related to a cost to update the subset of beams, a parameter about whether the best beam is included in the subset of beams, a parameter related to whether the best beam is near an edge of the subset of beams, or weightings associated with at least some of the set of available beams that relate to probabilities that the beams are included in the new subset of beams.

In one embodiment, the method further comprises providing a result of the evaluating (604) to another node for updating of a machine learning model used for beam subset selection.

In one embodiment, the method further comprises performing a fallback to a predefined subset of beams based on the evaluating. In one embodiment, the predefined subset of beams is the set of available beams.

Corresponding embodiments of a network node are also disclosed herein. In one embodiment, a network node for a wireless network that utilizes transmit and/or receive beamforming comprises processing circuitry configured to cause the network node to dynamically select a subset of beams for a particular wireless communication device, the subset of beams being a subset of a set of available beams and perform one or more actions based on the selected subset of beams. In one embodiment, the dynamic selection of the subset of beams for the particular wireless communication device comprises dynamic selection of which of a plurality of beams are included in the subset of beams for the particular wireless communication device.

Embodiments of methods related to training Machine Learning (ML) models utilized for beam subset selection and validation are also disclosed. In one embodiment, a computer-implemented method comprises receiving beam switch related information for a plurality of wireless communication devices and training a beam switch probability model that models a probability of a beam switch from any first beam in a set of available beams for a wireless network to any second beam in the set of available beams for the wireless network. In one embodiment, the method further comprises providing the beam switch probability model to a network node in the wireless network.

In another embodiment, a computer-implemented method comprises receiving beam measurement information for a plurality of wireless communication devices for a set of available beams in a wireless network and training a model that predicts a best beam from among the set of available beams for a wireless communication device based on measurements made by the wireless communication device for a subset of the set of available beams. In one embodiment, the method further comprises providing the model to a network node in the wireless network.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates one example of an existing static subset layout, which serves as the performance baseline for comparison to the performance of embodiments of the present disclosure;

FIG. 2 illustrates one example of a wireless communication system in which embodiments of the present disclosure may be implemented;

FIGS. 3A, 3B, and 3C illustrate one example of a beam switch probability matrix generated from simulated data, in accordance with one example embodiment of the present disclosure;

FIG. 4 illustrates one example of a Markov Chain with two states E and A, where, if the current state is E, there is a 30% chance to stay there and a 70% chance to switch to A;

FIG. 5 is a graphical representation of beam subset selection at different time instances in accordance with beam transition probabilities where the black-marked states represent widebeams that were selected in each measurement, the number of which depend on the specified subset size, in accordance with one embodiment of the present disclosure;

FIGS. 6A and 6B illustrate a flow chart describing a beam subset selection and validation procedure in accordance with one embodiment of the present disclosure;

FIG. 7 is a flow chart that illustrates a procedure performed by a computing node for training a beam subset selection model in accordance with one embodiment of the present disclosure;

FIG. 8 is a flow chart that illustrates a procedure performed by a computing node for training the beam subset validation model in accordance with one embodiment of the present disclosure;

FIG. 9 illustrates a simulator setup with visible theoretical beam grid which was used to generate experimental results for example embodiments of the present disclosure;

FIG. 10 illustrates an example of a time series of subset of beams generated by the Markov Chain subset selection implementation, in accordance with one example embodiment of the present disclosure;

FIG. 11 is a schematic block diagram of a node according to some embodiments of the present disclosure;

FIG. 12 is a schematic block diagram that illustrates a virtualized embodiment of the node of FIG. 11 according to some embodiments of the present disclosure;

FIG. 13 is a schematic block diagram of the node of FIG. 11 according to some other embodiments of the present disclosure;

FIG. 14 is a schematic block diagram of a wireless communication device (e.g., a User Equipment (UE)) according to some embodiments of the present disclosure;

FIG. 15 is a schematic block diagram of the wireless communication device of FIG. 14 according to some other embodiments of the present disclosure;

FIG. 16 illustrates a telecommunication network connected via an intermediate network to a host computer in accordance with some embodiments of the present disclosure;

FIG. 17 is a generalized block diagram of a host computer communicating via a base station with a UE over a partially wireless connection in accordance with some embodiments of the present disclosure;

FIG. 18 is a flowchart illustrating a method implemented in a communication system in accordance with one embodiment of the present disclosure;

FIG. 19 is a flowchart illustrating a method implemented in a communication system in accordance with one embodiment of the present disclosure;

FIG. 20 is a flowchart illustrating a method implemented in a communication system in accordance with one embodiment of the present disclosure; and

FIG. 21 is a flowchart illustrating a method implemented in a communication system in accordance with one embodiment of the present disclosure.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing an Access and Mobility Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include, but are not limited to: a User Equipment (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

There are certain challenges with existing solutions. The current static subset layout assumes that the environment does not distort the theoretical grid of beams, meaning that geographically neighboring beams are assumed to be the best alternatives to the currently strongest beam in the coming measurements. In reality, this is not the case as the environment around each deployment site is generally populated by buildings, elevation changes, trees, and other objects that significantly alter the propagation of electromagnetic waves.

Improving subset selection to reduce the discrepancy between the assumed grid layout and reality would in the main use-case improve reliability and signal strength. Quantification of the effectiveness and cost of a certain subset selection scheme can be achieved by counting the occurrences (or frequency of occurrence) of selected subsets which do not contain the best global widebeam, hereafter called beam misses. Another quality of the subset selection scheme effectiveness is the cost of running it. As mentioned above, updating states in distributed systems such as the main use-case presented herein comes at a cost which will hereafter be quantified as subset switches.

Other potential use-cases which could benefit from optimization of subset selection include digital receivers as they currently listen in all directions—meaning there is room for optimization of energy usage if subsets that determine in which directions to listen could be applied. The key take-away from this is that digital receivers are not distributed and updating states would thus come at the low cost of running the prediction function that selects the subset. What would in a distributed system be a balancing act between beam misses and subset switches (benefit vs cost) is theorized to simply improve performance without noteworthy drawback in a centralized system.

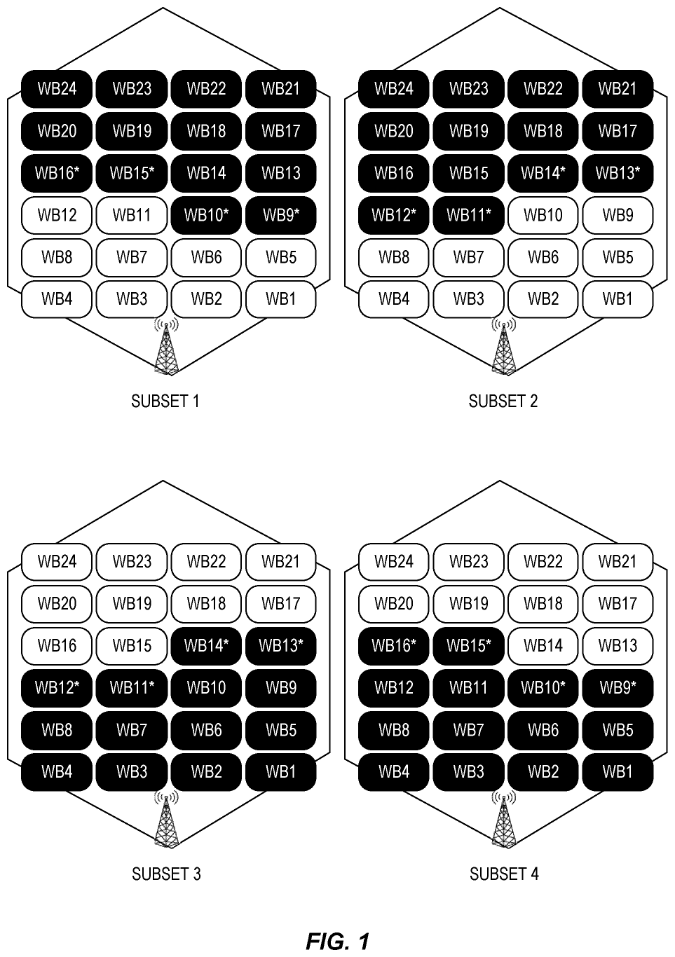

FIG. 1 illustrates one example of an existing static subset layout, which serves as the performance baseline for comparison to the performance of embodiments of the present disclosure. The current static subset implementation works by selecting between one of four pre-defined subsets of the available beams. The task of switching between them is handled through so-called border beams, marked with an asterisk (*) in FIG. 1. If a UE finds a border beam of its currently assigned subset to have the highest Reference Signal Received Power (RSRP), the UE will switch to the subset which: (1) includes the beam having the highest RSRP and (2) does not have this beam in its border set. The subsets are defined such that the overlap always allows for a legal switch whenever a border beam of the current subset is measured to have the highest RSRP.

Systems and methods are disclosed herein that provide a solution(s) to the aforementioned and/or other challenges. Embodiments of the present disclosure relate to of two main aspects: creating a subset of beams (from among a set of available beams) dynamically using data gathered from the environment and evaluating the subset of beams in order to decide whether to keep improving the subset or fall back to a predefined set of beams (e.g., a subset defined by the existing static implementation).

In one embodiment, a subset of beams is a dynamically selected based on a probability matrix (also referred to herein as a transition matrix) describing the likelihood, or probability, of transitioning from a state where beam X (e.g., a current serving beam of a wireless communication device) has highest RSRP to a state where beam Y has the highest RSRP in the next measurement report. In another embodiment, a probability matrix is transformed into a Markov chain that is used to dynamically generate, or select, subset of beams by repeatedly re-traversing the graph. In one embodiment, evaluation of the generated subset of beams is done using machine learning (e.g., Multilayer Perceptron Classifier).

Embodiments of the present disclosure may optimize beam subset selection to reduce beam misses and improve signal strength, availability, and reliability.

In some embodiments, either or both of the following aspects are included: (1) generating a subset of beams dynamically (e.g., in content (i.e., which beams), in size (i.e., number of beams), or both in content and size) based on gathered data and (2) evaluating said subset of beams, e.g., using Machine Learning, to decide between continuing to improve the subset of beams or falling back to a predefined subset of beams (e.g., a subset of beams as defined in the existing static subsets solution).

Embodiments of the present disclosure may provide a number of advantages. The dynamic selection of subsets in embodiments of the present disclosure is done using data gathered (e.g., from a non-line-of-sight simulation of a user traversing the radio environment surrounding the gNB or from data gathered from an actual live node with real users). In some embodiments, this enables the creation of a so-called beam switch probability matrix which holds information about the likelihood, or probability, of each beam having the best signal strength based on the current state of the system. Compared to the static implementation, this data-driven approach has shown improved results with respect to beam misses which translates directly to better optimization of how available resources are used, possibly improving metrics such as average RSRP, throughput, availability, and reliability. Combined with methods used to, in each time instance, evaluate the minimal size of the subsets that is still likely to satisfy the aforementioned metrics, it is also conceivable that energy consumption of the system could be lowered by reducing the average size of the subsets.

The other main component of the solution, which uses machine learning to evaluate the quality of the subset, provides the ability to give feedback to the component responsible for generating subsets. Note that beam subset selection may also be based on machine learning and data driven.

Combining these components and refining the feedback loop is thought to be a powerful alternative to current methods used to perform the task of subset selection in a wide range of applications.

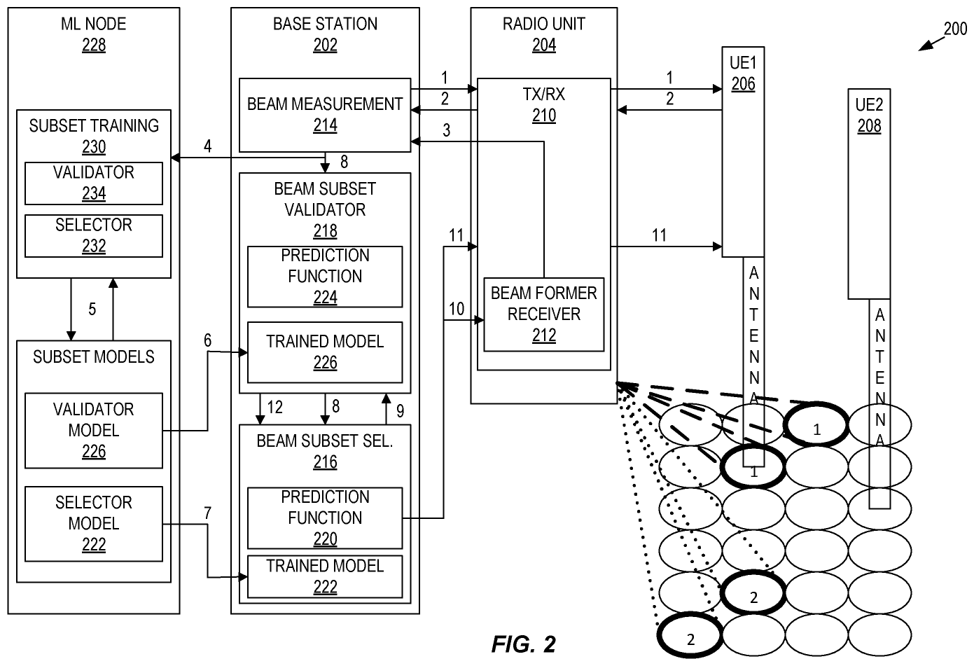

FIG. 2 illustrates one example of a wireless communication system 200 in which embodiments of the present disclosure may be implemented. In one example embodiment, the wireless communication system 200 is a 3GPP cellular communications system such as, e.g., a 5G System. Note that not all components or sub-components shown in FIG. 2 are needed for all embodiments. The wireless communication system 200 includes a base station 202 and an associated radio unit 204 that transmit wireless signals to and receive wireless signals from UEs such as, in this example embodiment, UEs 206 and 208. While illustrated separately, the base station 202 and the radio unit 204 may be implemented as separate network nodes or implemented in a single network node. The radio unit 204 includes transceiver circuitry 210 including a beam former receiver 212.

The base station 202 includes a beam measurement function 214, a beam subset selector 216, and a beam subset validator 218. In one example embodiment, the beam subset selector 216 includes a prediction function 220 that operates to dynamically predict, or select, subsets of beams for UEs such as, e.g., the UEs 206 and 208, based on a trained beam subset selection model 222. The trained beam subset selection model 222 may be, e.g., a Machine Learning (ML) model (e.g., a ML that predicts probabilities of a beam switch between any two beams or more generally a ML model that returns information that is translatable to an appropriate subset of beams), a beam switch matrix or transition matrix that stores or hold probabilities of a beam switch between any two beams, or the like. In one example embodiment, the beam subset validator 218 includes a prediction function 224 that operates to validate a beam subset by, e.g., predicting whether a best beam from among a set of available beams (e.g., a set of all available beams) is within a subset of beams configured for a particular UE (e.g., UE 206 or 208) based on one or more criteria such as, e.g., a current serving beam of the particular UE, one or more past serving beams of the particular UE, one or more beam measurements for one or more of the beams in the currently configured subset of beams for the particular UE, and/or the like. In one example embodiment, the prediction function 224 uses a trained beam subset validation model, which may be an ML model.

In one example embodiment, the beam subset selector 216 and the beam subset validator 218 use respective trained models 222 and 224. In this case, the system 200 may further include a ML node 228. The ML node 228 is a computing device or system, which may be part of or external to the base station 202. The ML node 228 includes a training function(s) 230 that includes a selector training function 232 that trains the beam subset selector model 222 and a validator training function 234 that trains the beam subset validator model 226.

The operation of the system 200 of FIG. 2 is as follows:

1. Signals used for beam measurement are continuously sent to the UE 206 (depends on use case).

2. Beam measurement reports are continuously received from the UE 206 (depends on the use case). In one example, measurements are reported for a limited number (e.g., 4) of the best (e.g., strongest) beams.

3. Beam measurements are continuously received from the beam former receiver 212 (depends on use case). These beam measurements can be for all available beams or a subset of all available beams.

4. The beam measurements from steps 2 and 3 are forwarded to the ML node 228 for training of the beam subset selection model 222 and the beam subset validation model 226. The beam measurements may also be forwarded to the beam subset selector 216 and the beam subset validator 218.
Note that step 4 is in the case of training the beam subset selection model 222 and the beam subset validation model 226 using live measurements. Alternatively, the beam subset selection model 222 and/or the beam subset validation model 226 may be trained offline using simulation data or previously collected data.

5. The ML node 228 trains the beam subset selection model 222 and the beam subset validation model 226 using any suitable ML training scheme for any suitable type of ML model(s). Note that this training is typically common for all UEs such that measurements from all connected UEs contribute to the building of one trained model for the radio environment at the base station site. Alternatively, separate models may be trained per UE or per UE type or per group of UEs (where UEs can be grouped in any suitable manner).

6. When the beam subset validation model 226 has sufficient accuracy, or is updated, it is sent to the beam subset validator 218.

7. When the beam subset selection model 222 has sufficient accuracy, or is updated, it is sent to the beam subset selector 216.

8. When measurements are received (in step 2 or 3) and the trained beam selection model 222 is available (step 7), the beam subset selector 216 predicts, or selects, a beam subset for the UE 206. The beam subset is a subset of a set of beams, where this set of beams may include, e.g., all available beams.

9. The predicted beam subset for the UE 206 is sent to the beam subset validator 218.

10. The predicted beam subset for the UE 206 is also sent to the beam former receiver 212. The beam former receiver 212 may process this beam subset or all beams (depends on use case).

11. Information related to the predicted beam subset is sent to the UE 206 (depends on the use case).

12. Beam measurements are continuously received in the beam subset validator 218 (from step 2 or 3),
a) If measurements from the predicted beam subset for the UE 206 are received according to step 2 or 3 and the trained beam subset validation model 226 is available or according to step 2 where the UE has measured only on a subset of beams, then the beam subset validator 218 predicts whether the predicted beam subset for the UE 206 includes the globally best beam for the UE 206 or not, based on these measurements.
b) Else, if measurements from all beams are received according to step 3, or measurements are received according to step 2 when the UE measures on all beams, then the globally best beam is known based on these measurements and thus whether the predicted beam subset contains the best beam or not is also known based on these measurements.
c) Information about whether the predicted beam subset for the UE 206 contains the best beam for the UE or not is fed back to the beam subset selector 216 and to the ML node 228. The feedback that goes directly to the beam subset selector 216 makes it possible to fast adjust the subset. The feedback to the ML node 228 makes it possible to adjust (re-train or reinforcement learning) the ML model, which typically has slower response until it reaches the subset Selector in step 7. The subset of beams selected for the UE 206 may then be updated based on this information (e.g., a new subset of beams may be selected for the UE 206 using, e.g., one or more new or updated selection criteria). In one embodiment, if the predicted beam subset for the UE 206 does not include the best beam for the UE 206 or does not include the best beam for the UE 206 some predefined or configured number of times (e.g., within a defined time period or consecutively), subset selection may fall back to a predefined subset of beams (e.g., the static subset of beams used, e.g., in the conventional solution).

Note that the sequence of steps 1-12 then repeats.

The right-hand side of FIG. 2 shows a simplified example of two different UEs 206 and 208 traversing an example beam grid layout while being assigned different subsets. In this example, the beam subsets are of size 2 and separated by indices (1, 2) depending on which UE they are assigned to. The UE 206 (also denoted as “UE 1”) is depicted to have found the highest RSRP to be in one of the beams that was selected to be part of the selected beam subset for the UE 206, which implies that a beam miss did not occur. The UE 208 (also denoted as “UE 2”) has found a beam outside the beam subset selected for the UE 208 to be the strongest, or best, beam for the UE 208, which represents a beam miss.

### Subset Selection Theory

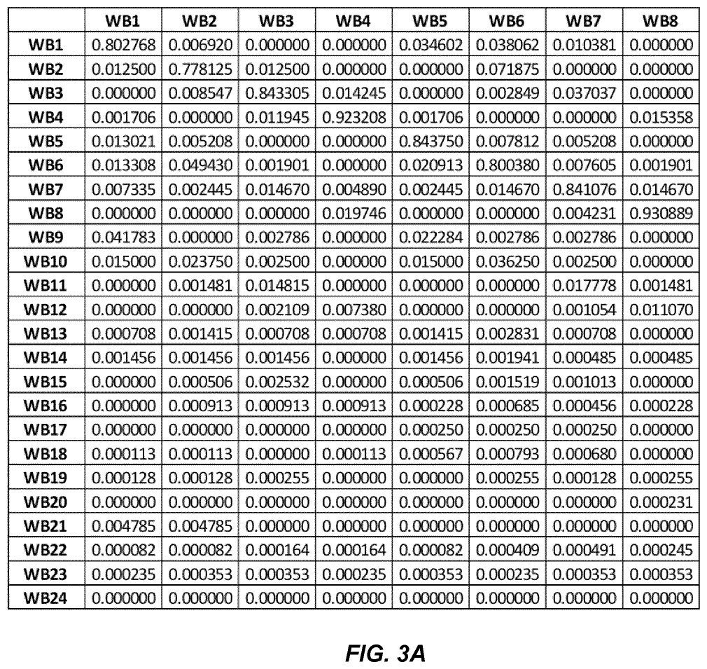

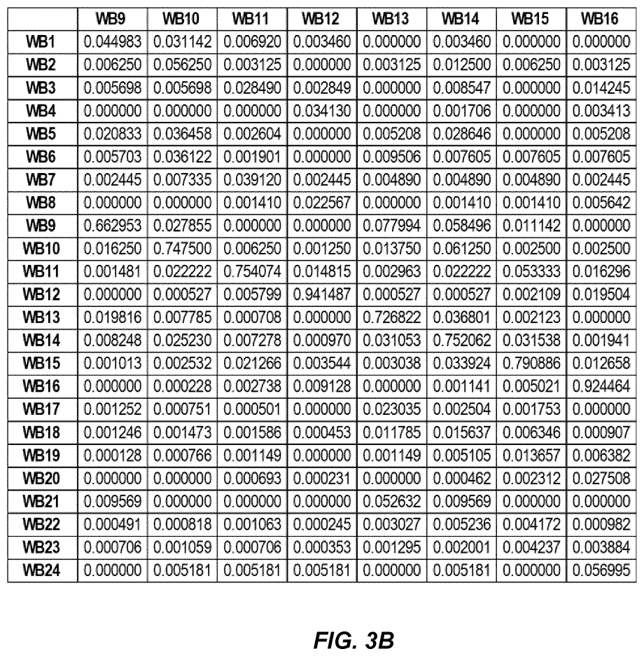

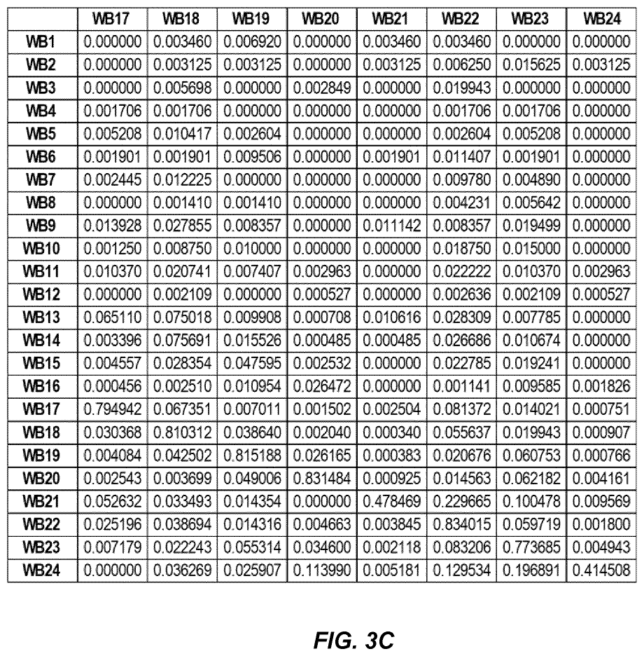

The first investigated method for selecting a beam subset, or subset of beams, that contains the widebeams most likely to be relevant for the near future is based on a probability matrix derived from previously seen beam switches in training data. The matrix was created by, for each row of logged RSRP values, tracking the index of the strongest beam throughout the simulation. It is also possible to combine values obtained from the simulation by biasing the matrix using the theoretical beam grid. In this example, there are 24 available beams, which results in a matrix of dimensions 24×24 where a row index corresponds to the current strongest beam and each of the values of that row contains probabilities of each of the other beams being the strongest in the following measurement report (See, e.g., FIGS. 3A-3B). For example, the first row tells us the probabilities of each beam being the strongest in the next report given that beam 1 is currently the strongest.

The real-world system architecture makes it possible for the base station 202 (e.g., gNB), which is responsible for beam subset selection, to store the limited number of (e.g., 4) widebeams with highest RSRP as measured by the UE. It is thus possible to select the relevant row of probabilities in the matrix, which can then be used to make educated guesses of which beams should be included in the subset.

The row of probabilities covers all outcomes, and it is thus possible to base the beam subset size (i.e., the number of beams included in the beam subset) of a percentile of the possible outcomes. An example of such a function can be defined as:

subsetSize=min(the number of beams that cover X% of potential outcomes,14)

Changing the size of the beam subset dynamically has the potential to reduce the resources required to effectively select the best physical channel for communication on the UE side. Furthermore, it is possible to traverse the matrix recursively to include beams that prove to be probable switches a number of steps away (likely to be included in the subset after the next one, possibly making it a good candidate also for the next subset).

Since the matrix describes the likelihood of transitioning between states, it is possible to represent it as a so-called Markov Chain. The following method to select subset members was then derived.

### Subset Selection Using Markov Chains

The Markov Chain stochastic model (graph) is an alternative representation of the information contained in the beam switch probability matrix. The Markov chains can be represented as a graph of states with probabilities of changing or staying. An example is given in FIG. 4.

It enables the possibility to choose members of a subset according to the probabilities via stochastic traversal of the graph.

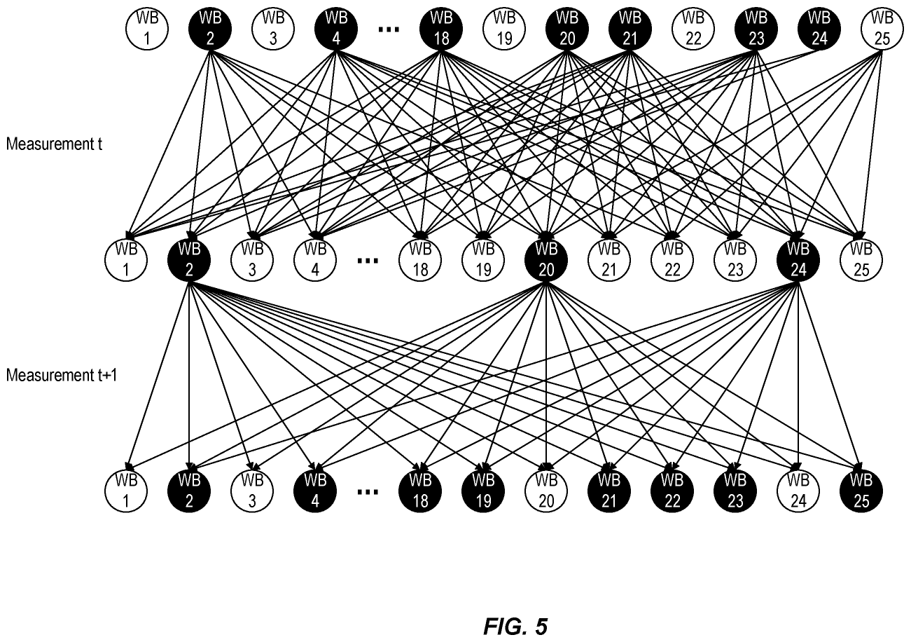

The graph depicted in FIG. 5 contains a number of nodes along with possible transitions (arrows) with probabilities corresponding to the beam switch probability matrix. Traversing this graph a specific number of times equal to the beam subset size yields the members of a beam subset that could serve the UE in the next measurement. In other words, FIG. 5 is a graphical representation of beam subset selection at different time instances in accordance with beam transition probabilities where the black-marked states represent widebeams that were selected in each measurement, the number of which depend on the specified subset size, in accordance with one embodiment of the present disclosure.

The size of the beam subset can either be hard-coded by the programmer or specified by a dedicated Machine Learning model which optimizes the size dynamically in runtime. The benefits of such a machine learning model comes from the possibility to reduce the average size of the subsets, ultimately reducing the data needed to be processed by the system. Data supporting this is presented in Table 1 below.

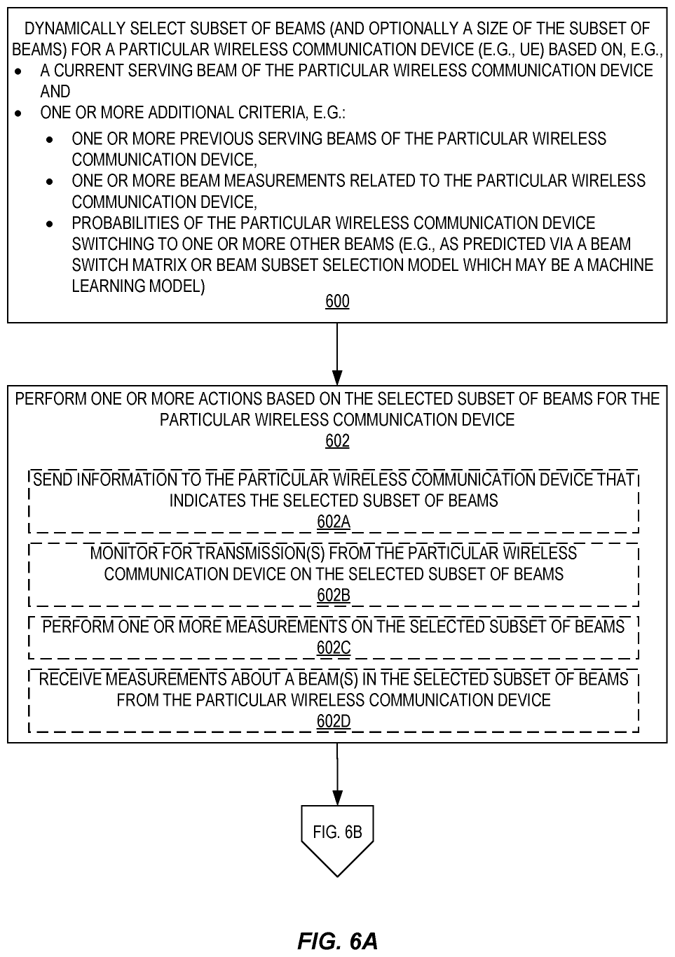

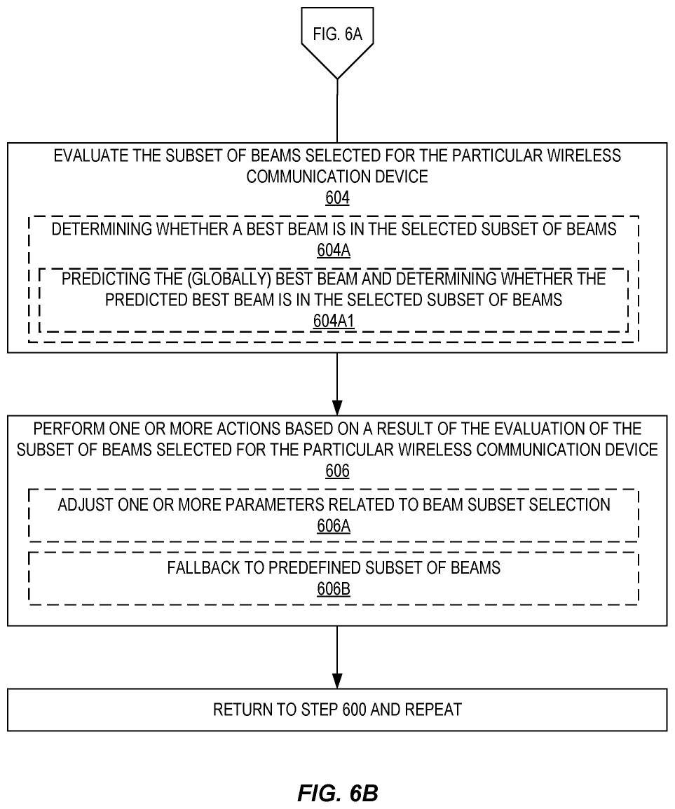

FIGS. 6A and 6B illustrate a flow chart describing a beam subset selection and validation procedure in accordance with one embodiment of the present disclosure. In the description of this procedure, references to the system 200 of FIG. 2 are made; however, the procedure of FIGS. 6A and 6B is not limited to the architecture of FIG. 2 and may be used in other wireless network architectures in which wireless communication devices (e.g., UEs) are configured with beam subsets.

As illustrated in FIGS. 6A and 6B, a network node (e.g., the base station 202) for a wireless network that utilizes transmit and/or receive beamforming dynamically selects a subset of beams for a particular wireless communication device (e.g., UE 206) (step 600). The subset of beams is a subset of a set of defined beams, which is preferably a set of (e.g., all) available beams for transmission and/or reception to the particular wireless communication device. The network node performs one or more actions based on the selected subset of beams (step 602).

In one embodiment, the one or more actions performed by the network node in step 602 include one or more actions that apply the selected subset of beams for the particular wireless communication device. For example, the one or more actions may include: (a) sending information that indicates the subset of beams to the particular wireless communication device (step 602A), (b) monitoring for transmissions from the particular wireless communication device on the subset of beams (step 602B), (c) performing one or more measurements on the subset of beams at the network node (step 602C), (d) receiving measurements about beams in the subset of beams from the particular wireless communication device (step 602D), or (e) a combination of any two or more of (a)-(d).

In one embodiment, the network node dynamically selects the subset of beams for the particular wireless communication device based on a current serving beam of the particular wireless communication device. Optionally, the selection of the subset of beams for the particular wireless communication device may be further based on one or more additional criteria such as, e.g., one or more previous serving beams of the particular wireless communication device, one or more beam measurements for a beam(s) in the set of available beams, one or more beam measurements for a beam(s) in the subset of beams selected for the particular wireless communication device, or both.

In one embodiment, the network node selects the subset of beams for the particular wireless communication device based on information that models or represents probabilities that the particular wireless communication device will switch from a current serving beam to each other beam in the set of available beams. As described above, in one embodiment, the information that models or represents the probabilities that the particular wireless communication device will switch from the current serving beam to each other beam in the set of available beams is a trained machine learning model (e.g., the trained beam subset selection model 222). In another embodiment, the information that models or represents the probabilities that the particular wireless communication device will switch from the current serving beam to each other beam in the set of available beams is a beam switch probability matrix or transition matrix, as described above. In another embodiment, the information that models or represents the probability that the particular wireless communication device will switch from the current serving beam to each other beam in the set of available beams is a Markov Chain stochastic model, or graph, as described above.

In one embodiment, as part of the selection of the subset of beams for the particular wireless communication device, the network node dynamically determines or selects a size of the subset of beams based on the probabilities.

In one embodiment, the one or more actions performed in step 602 includes receiving, from the wireless communication device, one or more measurements for at least one beam in the subset of beams, and the network node evaluates the subset of beams based on the one or more measurements for the at least one beam in the subset of beams (step 604). In one embodiment, evaluation of the subset of beams includes determining whether the subset of beams comprises a best beam from among the set of available beams for the particular wireless communication device, based on the one or more measurements for each beam in the subset of beams (step 604A). This may include predicting whether the best beam is in the subset of beams using a model such as, e.g., the trained beam subset validation model 226. In one embodiment, this includes predicting the best beam (e.g., using a ML model) and determining whether the predicted best beam is included in the subset of beams selected for the particular wireless communication device (step 604A1). Note that the best beam for the particular wireless communication device is, in one embodiment, one beam in the set of available beams for which the particular wireless communication device has or is predicted to have a highest received power, a highest reference signal received power, a highest reference signal received quality, a highest signal to noise ratio, a highest signal to interference plus noise ratio, a highest received strength of signal, a highest code rate, a lowest block error rate, a highest channel quality, highest throughput, a lowest amount of associated control signaling, or a lowest probability of triggering a change in the subset of beams.

As discussed above, in one embodiment, the evaluation or validation of the subset of beams is based on the measurement(s) received for at least one beam (but possibly all beams) in the set of available beams or measurement(s) received for at least one beam (but possibly all beams) in the subset of beams, and a machine learning model (e.g., the beam subset validation model 226). In one embodiment, the machine learning model predicts the best beam for the wireless communication device from among the set of available beams based on the one or more measurements for at least one beam in the set of available beams or based on the one or more measurements for at least one beam in the subset of beams.

In one embodiment, based on a result of the evaluation in step 604, the network node performs one or more actions (step 606). In one embodiment, the one or more actions include adjusting one or more parameters related to selection of a subset of beams (step 606A). For example, based on the evaluation, weightings applied to the beams for beam subset selection may be adjusted such that their likelihood of being included in the subset are altered. The process may then return to step 600 where a new subset of beams is selected for the particular wireless communication device based on the one or more adjusted parameters. In one embodiment, the one or more adjusted parameters comprise a parameter related to a number of beams included in the new subset of beams, a parameter related to a number of beams needed in the subset of beams to satisfy a predefined or configured accuracy related to a mishit of a best beam from the set of available beams for the particular wireless communication device being within the subset of beams, one or more parameters related to a cost to update the subset of beams, a parameter about whether the best beam is included in the subset of beams, a parameter related to whether the best beam is near an edge of the subset of beams, and/or weightings associated with at least some of the set of available beams that relate to probabilities that the beams are included in the new subset of beams.

In another embodiment, based on a result of the evaluation, the network node performs a fallback to a predefined subset of beams for the wireless communication device (step 606B). The predefined subset of beams is, in one embodiment, the set of available beams or a static set of beams (e.g., a set of beams in accordance with the conventional solution described above). For example, if the (predicted) best beam is not in the selected subset of beams, the network node may fall back to the predefined subset of beams. As another example, if the (predicted) best beam is not in the selected subset of beams for the particular wireless communication device after N iterations of the procedure of FIGS. 6A and 6B (e.g., after adjusting the parameter(s) used for beam subset selection N−1 times, where N is predefined or configured integer number that is greater than or equal to 2), the network node performs fallback to the predefined subset of beams.

FIG. 7 is a flow chart that illustrates a procedure performed by a computing node (e.g., the ML node 228) for training the beam subset selection model 222 in accordance with one embodiment of the present disclosure. As illustrated, the computing node receives beam switch related information for multiple wireless commination devices (e.g., for UEs) (step 700) and trains the beam subset selection model 222 based on the received beam switch related information (step 702). The beam switch related information may include, for example, information that indicates, for each of many beam switch events, the source beam and the target beam for the beam switch (i.e., the serving beam before the beam switch and the serving beam after the beam switch). The beam switch related information may include additional information such as, e.g., information that indicates whether the beam switch was successful or failed, etc. The beam switch related information may be live data (i.e., data collected during deployment) or previously collected data. In other words, the beam subset selection model 222 may be trained during deployment (i.e., based on live data) or trained beforehand. Any suitable ML training procedure may be used.

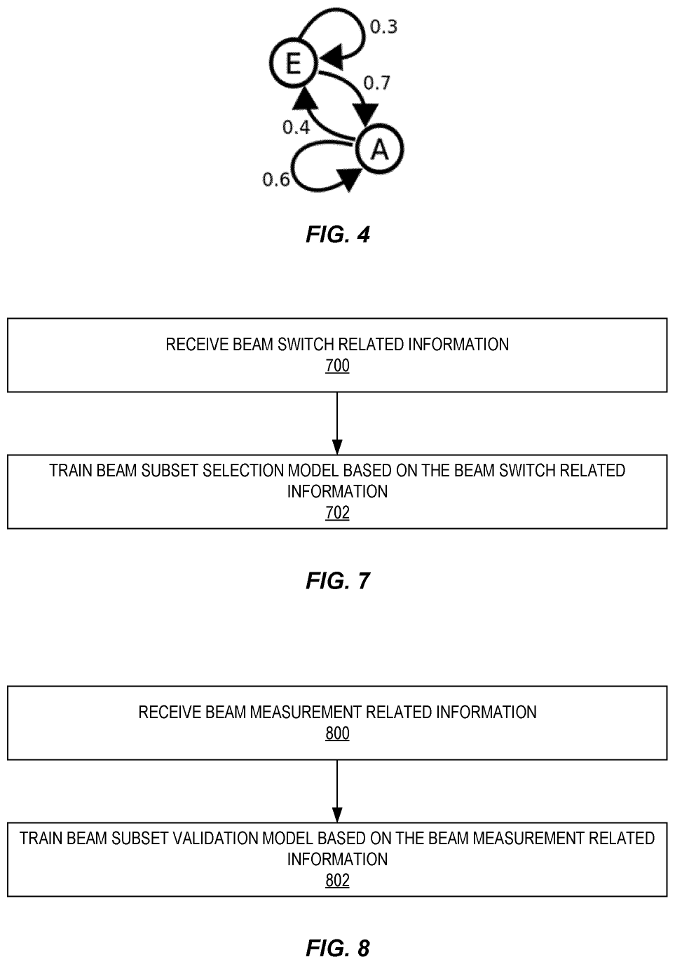

FIG. 8 is a flow chart that illustrates a procedure performed by a computing node (e.g., the ML node 228) for training the beam subset validation model 226 in accordance with one embodiment of the present disclosure. As illustrated, the computing node receives beam measurement related information for multiple wireless commination devices (e.g., for UEs) (step 800) and trains the beam subset validation model 226 based on the received beam measurement related information (step 802). The beam switch validation information may include, for example, RSRP measurements for one or more beams made for a wireless communication device for a given measurement interval or time (e.g., reported in the same measurement report). This information may be used, for example, to train the beam subset validation model to predict the best (or strongest) beam for any given wireless communication device based on measurements for at least some of the available beams or for at least some of the beams in the subset of beams selected for that wireless communication device. The beam measurement related information may be live data (i.e., data collected during deployment) or previously collected data. In other words, the beam subset validation model 226 may be trained during deployment (i.e., based on live data) or trained beforehand. Any suitable ML training procedure may be used.

Note that the procedure of FIGS. 6A and 6B combines the operation of a beam subset generator/selector and a beam subset validator (also referred to herein as a beam subset evaluator) in a feedback loop. This approach allows for great flexibility and has the potential to improve performance across a wide range of applications—both in the widebeam scenario explored in the experimental results below and in other scenarios where subset quality indicators are not immediately available via reporting. This is depicted as an OR statement implying that the information about subset quality could either be retrieved via the information being readily available in the system or evaluated using a Machine Learning model.

The condition of the best widebeam being in the subset would likely be incorporated into the ML subset evaluator, but in the experimental results below, it is separate since the evaluator implemented in experiments simply predicts the strongest global beam based on a subset. It is possible to augment the ML subset evaluator such that it yields more information (example: predicted best beam+confidence in prediction) that could be used to refine the subset more effectively. The module responsible for adjusting the subset should be seen as responsible for updating meta-data (e.g., parameters related to beam subset selection) that is used in the beam subset selection step.

Method Applied to Simulation Data from Radio Environment Simulator

This subsection presents the data that was retrieved from running the gathered environment data through the Markov subset selection scheme. It also presents results from a Machine Learning model relevant to the validation procedure.

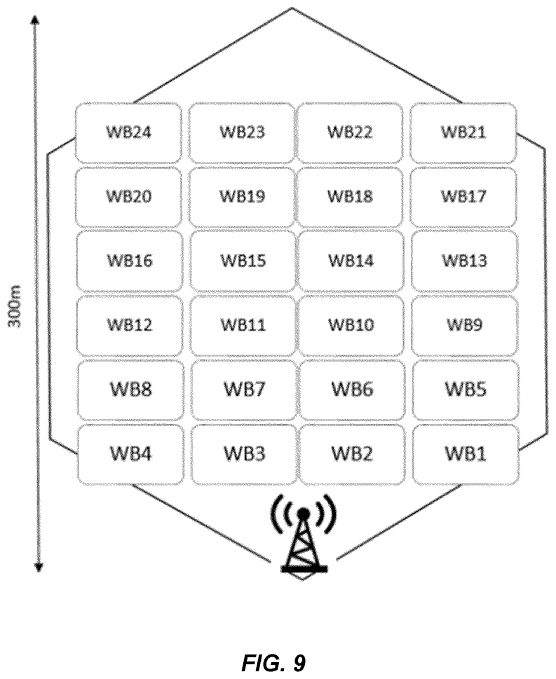

The data used for testing the following method was generated using the radio environment simulator which was configured to simulate one user traversing a hexagonal area with radius 150 meters (m) (i.e., the distance across the hexagonal area is 300 m), with the base station located at the bottom vertex of the hexagon (see FIG. 9). The deployment was configured to simulate a radio with 24 wide beams arranged in a 6×4 cell grid. The UE's RSRP measurements for each of the 24 wide beams were logged along with the UE location within the hexagon.

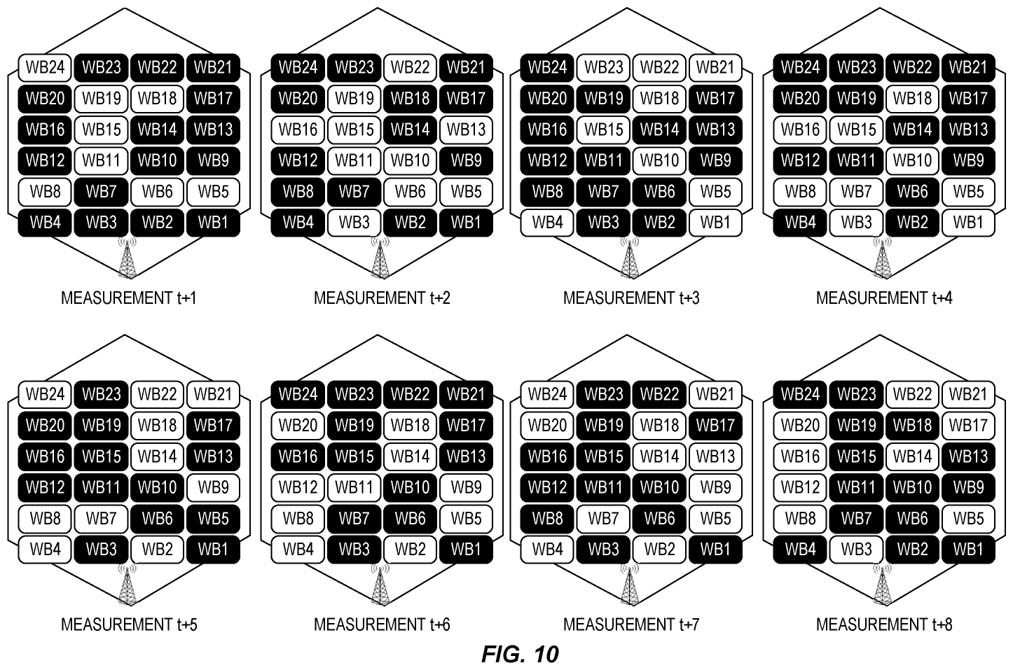

FIG. 10 shows an example of the time series of subsets generated by the Markov Chain subset selection implementation. Since the probabilities used to make the stochastic decisions are based on data gathered from the environment, there is a strong argument for the possibility of improving performance compared to a static subset implementation. It serves as a good indicator that similar data-driven or Machine Learning based methods could eventually be developed to further improve the results compared to the static implementation.

As explained above, the size of the subsets generated by the Markcov method can be specified either by the programmer or a dedicated Machine Learning algorithm. Performance data that can be compared to the baseline implementation has been gathered and the results show that the Markcov method is a promising alternative.

The results presented in Table 1 shows the effect that the subset size has on the average RSRP, beam switches and beam misses. It should be noted that the number of beam misses are decreasing with an increased subset size while the average RSRP does not change notably. This indicates that a Machine Learning model capable of predicting opportunities to temporarily decrease the subset size (time instances where the likelihood of the best global beam being in the selected smaller subset is high) could lower the average subset size while maintaining the same number of beam misses. This would result in, on average, less state variables that need to be processed by the system, ultimately reducing required processing power and energy consumption.

Comparing Table 1 to the baseline performance presented in Table 2, one can see that the static subset method with subset size 14 results in more beam misses than the Markov method using a fixed subset size of larger than or equal to 12.

TABLE 1
Performance of the Markov method implementation
for different subset sizes.

| | | Average Beam | |
|---|---|---|---|
| Subset Size | Average RSRP | Switches | Misses |
| 4 | −102.9938557 | 10656 | 8634 |
| 5 | −102.7855788 | 11252 | 5759 |
| 6 | −102.7036968 | 11439 | 4117 |
| 7 | −102.6272762 | 11520 | 2942 |
| 8 | −102.584603 | 11598 | 2036 |
| 9 | −102.5610553 | 11604 | 1554 |
| 10 | −102.5403559 | 11625 | 1178 |
| 11 | −102.5325539 | 11640 | 922 |
| 12 | −102.5181124 | 11587 | 649 |
| 13 | −102.5133811 | 11636 | 511 |
| 14 | −102.507385 | 11625 | 354 |
| 15 | −102.5047963 | 11610 | 275 |

TABLE 2
Static-subset baseline performance with subset size 14.
Baseline

| | |
|---|---|
| Average RSRP | −102.507235 |
| Misses | 719 |
| Average Beam Switches | 10403 |

### Using Machine Learning to Validate a Subset

The potential of using Machine Learning to validate the subsets was also investigated. The model used was a Multilayer Perceptron Classifier, a neural network, which was trained using labeled data created from the recorded subsets (produced by a method also derived from the beam switch probability matrix) along with the highest RSRP global beam from the corresponding measurement as the label. The input consisted of a list of 24 numeric values, where each index represented a certain widebeam, and the associated value was set to either the recorded RSRP for that beam in case it was included in the subset and 0 otherwise. There were also two hidden layers of 120 and 60 nodes, respectively. The output layer consisted of 24 nodes, again corresponding to the beam indexes, of which only one was returned as the predicted highest RSRP global widebeam.

This is a very good result that strongly indicates that it is feasible to train a Machine Learning model to evaluate the subset quality. There is great potential in extending the model to also return a confidence indicator that would enable more precise adjustments of the subsets in the feedback loop.

To summarize, the subset selector in the tests is based on the probability matrix and the probability matrix is based on data from the environment. The authors see great potential in combining the subset selector with the subset evaluator in a feedback loop constituting the main component in a self-regulating subset management system. Another approach is to apply reinforcement learning to adapt to any changes in the environment such as weather, objects, elevation changes, and construction sites. The general idea of using the subset evaluator to influence the subset generator would in a practical implementation be more sophisticated and provide probabilities and optimal subset size estimations used to determine if the selector model can handle the issue or if the system should fall back to the static layout before restarting the tracking process from there.

Results show that the data-driven Markov method already outperforms the static subset implementation for sizes larger than or equal to 12. It also carries the potential to further extend the performance gap by combining it with a dynamic subset size determined by a Machine Learning model.

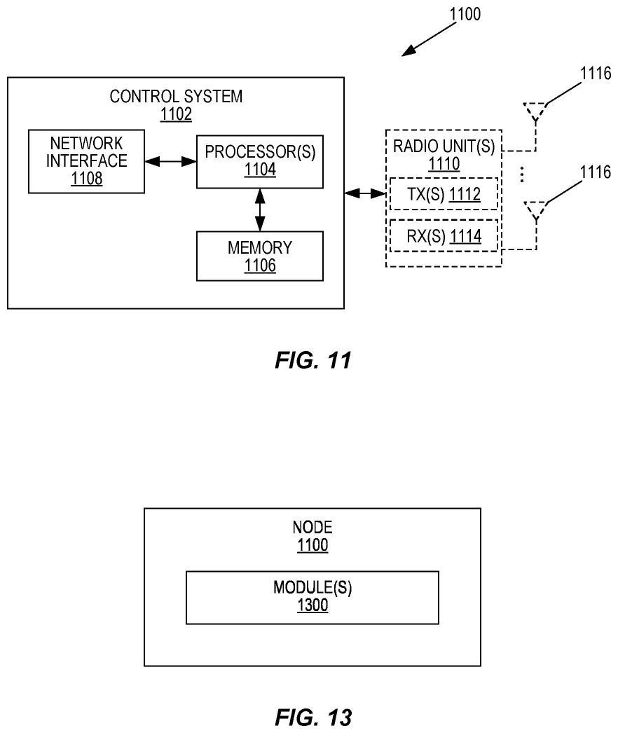

FIG. 11 is a schematic block diagram of a node 1100 according to some embodiments of the present disclosure. Optional features are represented by dashed boxes. The node 1100 may be, for example, the base station 202 or a network node that implements all or part of the functionality of the base station 202 described herein. The network node 1100 may, as another example, be the ML node 228. As illustrated, the node 1100 includes a control system 1102 that includes one or more proc1104essors 1404 (e.g., Central Processing Units (CPUs), Application Specific Integrated Circuits (ASICs), Field Programmable Gate Arrays (FPGAs), and/or the like), memory 1106, and a network interface 1108. The one or more processors 1104 are also referred to herein as processing circuitry. In addition, if the node 1100 is the base station 202, the network node 1100 may include one or mor110e radio units 1410 (e.g., the radio unit 204) that each includes one or more transmitters 1112 and one or more receivers 1114 coupled to one or more antennas 1116. The radio units 1110 may be referred to or be part of radio interface circuitry. In some embodiments, the radio unit(s) 1410 is external to the control system 1102 and connected to the control system 1102 via, e.g., a wired connection (e.g., an optical cable). However, in some other embodiments, the radio unit(s) 1410 and potentially the antenna(s) 1416 are integrated together with the control system 1102. The one or more processors 1104 operate to provide one or more functions of the node 1100 as described herein (e.g., one or more functions of the base station 202 described herein, e.g., with respect to FIG. 2 or one or more functions of the ML node 228 described herein, e.g., with respect to FIG. 7 and/or FIG. 8). In some embodiments, the function(s) are implemented in software that is stored, e.g., in the memory 1106 and executed by the one or more processors 1104.

FIG. 12 is a schematic block diagram that illustrates a virtualized embodiment of the node 1100 according to some embodiments of the present disclosure. Again, optional features are represented by dashed boxes. As used herein, a “virtualized” node is an implementation of the node 1100 in which at least a portion of the functionality of the node 1100 is implemented as a virtual component(s) (e.g., via a virtual machine(s) executing on a physical processing node(s) in a network(s)). As illustrated, in this example, if the node 1100 is the base station 202, the node 1100 may include the control system 1102 and/or the one or more radio units 1110, as described above. The control system 1102 may be connected to the radio unit(s) 1410 via, for example, an optical cable or the like. The node 1100 includes one or more processing nodes 1200 coupled to or included as part of a network(s) 1502. If present, the control system 1102 or the radio unit(s) are connected to the processing node(s) 1500 via the network 1202. Each processing node 1200 includes one or more proc1204essors 1504 (e.g., CPUs, ASICs, FPGAs, and/or the like), memory 1206, and a network interface 1208.

In this example, functions 1210 of the node 1100 described herein (e.g., one or more functions of the base station 202 described herein or one or more functions of the ML node 228 described herein) are implemented at the one or more processing nodes 1200 or distributed across the one or more processing nodes 1200 and the control system 1102 and/or the radio unit(s) 1410 in any desired manner. In some particular embodiments, some or all of the functions 1210 of the node 1100 described herein are implemented as virtual components executed by one or more virtual machines implemented in a virtual environment(s) hosted by the processing node(s) 1500. As will be appreciated by one of ordinary skill in the art, additional signaling or communication between the processing node(s) 1500 and the control system 1102 is used in order to carry out at least some of the desired functions 1210. Notably, in some embodiments, the control system 1102 may not be included, in which case the radio unit(s) 1410 communicate directly with the processing node(s) 1500 via an appropriate network interface(s).

In some embodiments, a computer program including instructions which, when executed by at least one processor, causes the at least one processor to carry out the functionality of the node 1100 or a node (e.g., a processing node 1200) implementing one or more of the functions 1210 of the node 1100 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 13 is a schematic block diagram of the node 1100 according to some other embodiments of the present disclosure. The node 1100 includes one or more modules 1300, each of which is implemented in software. The module(s) 1600 provide the functionality of the node 1100 described herein. This discussion is equally applicable to the processing node 1200 of FIG. 12 where the modules 1300 may be implemented at one of the processing nodes 1200 or distributed across multiple processing nodes 1200 and/or distributed across the processing node(s) 1500 and the control system 1102.

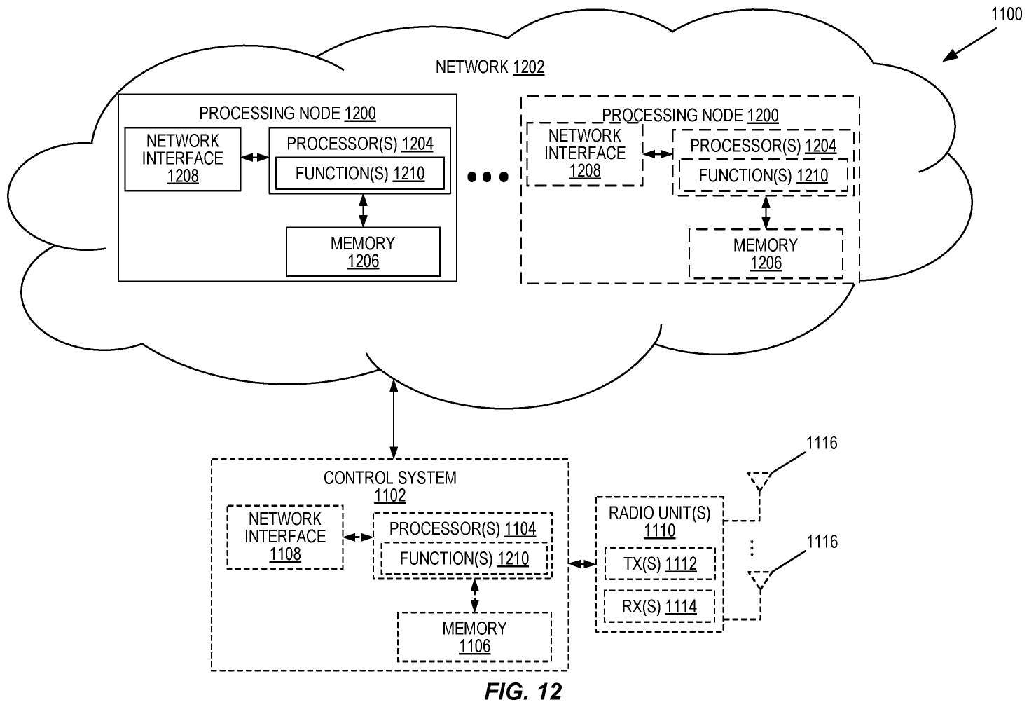

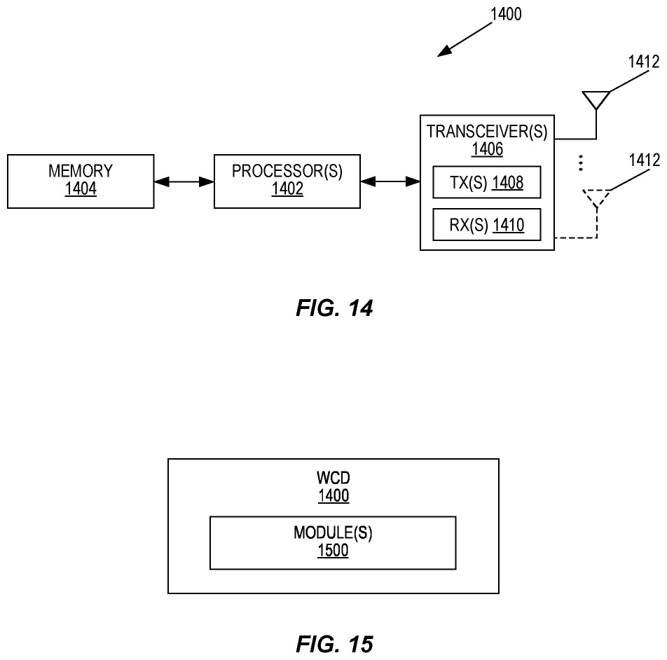

FIG. 14 is a schematic block diagram of a wireless communication device 1400 (e.g., a UE) according to some embodiments of the present disclosure. As illustrated, the wireless communication device 1400 includes one or more processors 1402 (e.g., CPUs, ASICs, FPGAs, and/or the like), memory 1404, and one or more transceivers 1406 each including one or more transmitters 1408 and one or more receivers 1410 coupled to one or more antennas 1412. The transceiver(s) 1706 includes radio-front end circuitry connected to the antenna(s) 1712 that is configured to condition signals communicated between the antenna(s) 1712 and the processor(s) 1702, as will be appreciated by on of ordinary skill in the art. The processors 1402 are also referred to herein as processing circuitry. The transceivers 1406 are also referred to herein as radio circuitry. In some embodiments, the functionality of the wireless communication device 1400 (or UE) described above may be fully or partially implemented in software that is, e.g., stored in the memory 1404 and executed by the processor(s) 1702. Note that the wireless communication device 1400 may include additional components not illustrated in FIG. 14 such as, e.g., one or more user interface components (e.g., an input/output interface including a display, buttons, a touch screen, a microphone, a speaker(s), and/or the like and/or any other components for allowing input of information into the wireless communication device 14001400 and/or allowing output of information from the wireless communication device 1400), a power supply (e.g., a battery and associated power circuitry), etc.

In some embodiments, a computer program including instructions which, when executed by at least one processor, causes the at least one processor to carry out the functionality of the wireless communication device 1400 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 15 is a schematic block diagram of the wireless communication device 1400 according to some other embodiments of the present disclosure. The wireless communication device 1400 includes one or more modules 1500, each of which is implemented in software. The module(s) 1800 provide the functionality of the wireless communication device 1400 (or UE) described herein.

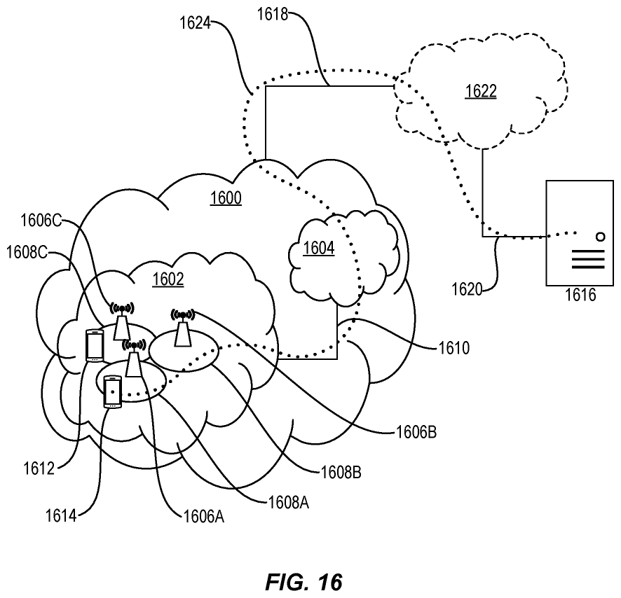

With reference to FIG. 16, in accordance with an embodiment, a communication system includes a telecommunication network 1600, such as a 3GPP-type cellular network, which comprises an access network 1602, such as a RAN, and a core network 1604. The access network 1602 comprises a plurality of base stations 1606A, 1606B, 1606C, such as Node Bs, eNBs, gNBs, or other types of wireless Access Points (APs), each defining a corresponding coverage area 1608A, 1608B, 1608C. Each base station 1606A, 1606B, 1606C is connectable to the core network 1604 over a wired or wireless connection 1610. A first UE 1612 located in coverage area 1608C is configured to wirelessly connect to, or be paged by, the corresponding base station 1606C. A second UE 1614 in coverage area 1608A is wirelessly connectable to the corresponding base station 1606A. While a plurality of UEs 1612, 1614 are illustrated in this example, the disclosed embodiments are equally applicable to a situation where a sole UE is in the coverage area or where a sole UE is connecting to the corresponding base station 1606.

The telecommunication network 1600 is itself connected to a host computer 1616, which may be embodied in the hardware and/or software of a standalone server, a cloud-implemented server, a distributed server, or as processing resources in a server farm. The host computer 1616 may be under the ownership or control of a service provider, or may be operated by the service provider or on behalf of the service provider. Connections 1618 and 1620 between the telecommunication network 1600 and the host computer 1616 may extend directly from the core network 1604 to the host computer 1616 or may go via an optional intermediate network 1622. The intermediate network 1622 may be one of, or a combination of more than one of, a public, private, or hosted network; the intermediate network 1622, if any, may be a backbone network or the Internet; in particular, the intermediate network 1622 may comprise two or more sub-networks (not shown).

The communication system of FIG. 16 as a whole enables connectivity between the connected UEs 1612, 1614 and the host computer 1616. The connectivity may be described as an Over-the-Top (OTT) connection 1624. The host computer 1616 and the connected UEs 1612, 1614 are configured to communicate data and/or signaling via the OTT connection 1624, using the access network 1602, the core network 1604, any intermediate network 1622, and possible further infrastructure (not shown) as intermediaries. The OTT connection 1624 may be transparent in the sense that the participating communication devices through which the OTT connection 1624 passes are unaware of routing of uplink and downlink communications. For example, the base station 1606 may not or need not be informed about the past routing of an incoming downlink communication with data originating from the host computer 1616 to be forwarded (e.g., handed over) to a connected UE 1612. Similarly, the base station 1606 need not be aware of the future routing of an outgoing uplink communication originating from the UE 1612 towards the host computer 1616.

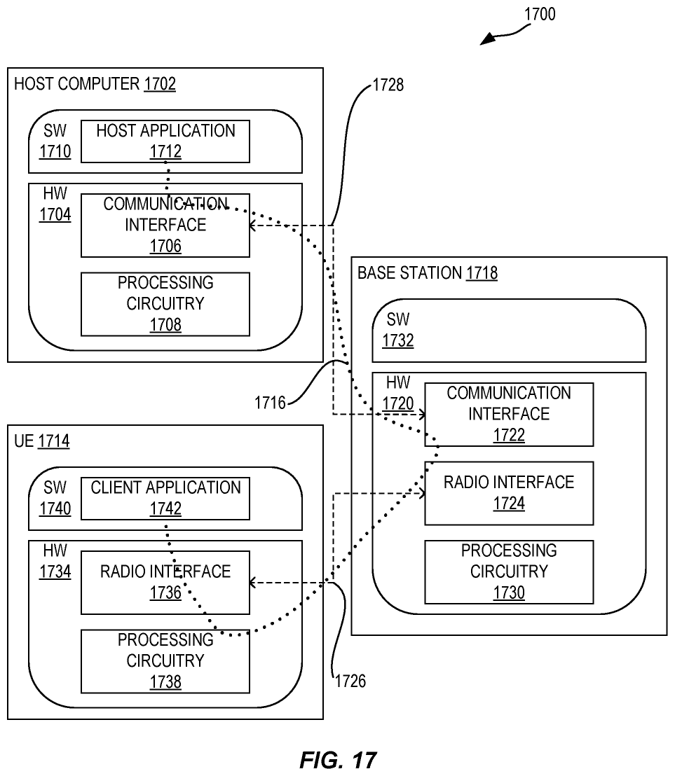

Example implementations, in accordance with an embodiment, of the UE, base station, and host computer discussed in the preceding paragraphs will now be described with reference to FIG. 17. In a communication system 1700, a host computer 1702 comprises hardware 1704 including a communication interface 1706 configured to set up and maintain a wired or wireless connection with an interface of a different communication device of the communication system 1700. The host computer 1702 further comprises processing circuitry 1708, which may have storage and/or processing capabilities. In particular, the processing circuitry 1708 may comprise one or more programmable processors, ASICs, FPGAs, or combinations of these (not shown) adapted to execute instructions. The host computer 1702 further comprises software 1710, which is stored in or accessible by the host computer 1702 and executable by the processing circuitry 1708. The software 1710 includes a host application 1712. The host application 1712 may be operable to provide a service to a remote user, such as a UE 1714 connecting via an OTT connection 1716 terminating at the UE 1714 and the host computer 1702. In providing the service to the remote user, the host application 1712 may provide user data which is transmitted using the OTT connection 1716.

The communication system 1700 further includes a base station 1718 provided in a telecommunication system and comprising hardware 1720 enabling it to communicate with the host computer 1702 and with the UE 1714. The hardware 1720 may include a communication interface 1722 for setting up and maintaining a wired or wireless connection with an interface of a different communication device of the communication system 1700, as well as a radio interface 1724 for setting up and maintaining at least a wireless connection 1726 with the UE 1714 located in a coverage area (not shown in FIG. 17) served by the base station 1718. The communication interface 1722 may be configured to facilitate a connection 1728 to the host computer 1702. The connection 1728 may be direct or it may pass through a core network (not shown in FIG. 17) of the telecommunication system and/or through one or more intermediate networks outside the telecommunication system. In the embodiment shown, the hardware 1720 of the base station 1718 further includes processing circuitry 1730, which may comprise one or more programmable processors, ASICs, FPGAs, or combinations of these (not shown) adapted to execute instructions. The base station 1718 further has software 1732 stored internally or accessible via an external connection.

The communication system 1700 further includes the UE 1714 already referred to. The UE's 2014 hardware 1734 may include a radio interface 1736 configured to set up and maintain a wireless connection 1726 with a base station serving a coverage area in which the UE 1714 is currently located. The hardware 1734 of the UE 1714 further includes processing circuitry 1738, which may comprise one or more programmable processors, ASICs, FPGAs, or combinations of these (not shown) adapted to execute instructions. The UE 1714 further comprises software 1740, which is stored in or accessible by the UE 1714 and executable by the processing circuitry 1738. The software 1740 includes a client application 1742. The client application 1742 may be operable to provide a service to a human or non-human user via the UE 1714, with the support of the host computer 1702. In the host computer 1702, the executing host application 1712 may communicate with the executing client application 1742 via the OTT connection 1716 terminating at the UE 1714 and the host computer 1702. In providing the service to the user, the client application 1742 may receive request data from the host application 1712 and provide user data in response to the request data. The OTT connection 1716 may transfer both the request data and the user data. The client application 1742 may interact with the user to generate the user data that it provides.

It is noted that the host computer 1702, the base station 1718, and the UE 1714 illustrated in FIG. 17 may be similar or identical to the host computer 1616, one of the base stations 1606A, 1606B, 1606C, and one of the UEs 1612, 1614 of FIG. 16, respectively. This is to say, the inner workings of these entities may be as shown in FIG. 17 and independently, the surrounding network topology may be that of FIG. 16.

In FIG. 17, the OT connection 1716 has been drawn abstractly to illustrate the communication between the host computer 1702 and the UE 1714 via the base station 1718 without explicit reference to any intermediary devices and the precise routing of messages via these devices. The network infrastructure may determine the routing, which may be configured to hide from the UE 1714 or from the service provider operating the host computer 1702, or both. While the OTT connection 1716 is active, the network infrastructure may further take decisions by which it dynamically changes the routing (e.g., on the basis of load balancing consideration or reconfiguration of the network).

The wireless connection 1726 between the UE 1714 and the base station 1718 is in accordance with the teachings of the embodiments described throughout this disclosure. One or more of the various embodiments improve the performance of OTT services provided to the UE 1714 using the OTT connection 1716, in which the wireless connection 1726 forms the last segment.

A measurement procedure may be provided for the purpose of monitoring data rate, latency, and other factors on which the one or more embodiments improve. There may further be an optional network functionality for reconfiguring the OTT connection 1716 between the host computer 1702 and the UE 1714, in response to variations in the measurement results. The measurement procedure and/or the network functionality for reconfiguring the OTT connection 1716 may be implemented in the software 1710 and the hardware 1704 of the host computer 1702 or in the software 1740 and the hardware 1734 of the UE 1714, or both. In some embodiments, sensors (not shown) may be deployed in or in association with communication devices through which the OTT connection 1716 passes; the sensors may participate in the measurement procedure by supplying values of the monitored quantities exemplified above, or supplying values of other physical quantities from which the software 1710, 1740 may compute or estimate the monitored quantities. The reconfiguring of the OTT connection 1716 may include message format, retransmission settings, preferred routing, etc.; the reconfiguring need not affect the base station 1718, and it may be unknown or imperceptible to the base station 1718. Such procedures and functionalities may be known and practiced in the art. In certain embodiments, measurements may involve proprietary UE signaling facilitating the host computer's 2002 measurements of throughput, propagation times, latency, and the like. The measurements may be implemented in that the software 1710 and 1740 causes messages to be transmitted, in particular empty or ‘dummy’ messages, using the OTT connection 1716 while it monitors propagation times, errors, etc.

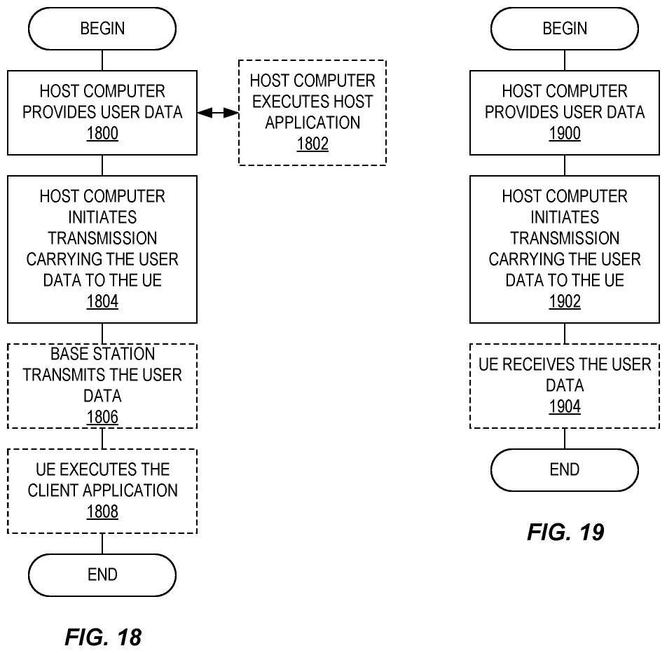

FIG. 18 is a flowchart illustrating a method implemented in a communication system, in accordance with one embodiment. The communication system includes a host computer, a base station, and a UE which may be those described with reference to FIGS. 16 and 17. For simplicity of the present disclosure, only drawing references to FIG. 18 will be included in this section. In step 1800, the host computer provides user data. In sub-step 1802 (which may be optional) of step 1800, the host computer provides the user data by executing a host application. In step 1804, the host computer initiates a transmission carrying the user data to the UE. In step 1806 (which may be optional), the base station transmits to the UE the user data which was carried in the transmission that the host computer initiated, in accordance with the teachings of the embodiments described throughout this disclosure. In step 1808 (which may also be optional), the UE executes a client application associated with the host application executed by the host computer.

FIG. 19 is a flowchart illustrating a method implemented in a communication system, in accordance with one embodiment. The communication system includes a host computer, a base station, and a UE which may be those described with reference to FIGS. 16 and 17. For simplicity of the present disclosure, only drawing references to FIG. 19 will be included in this section. In step 1900 of the method, the host computer provides user data. In an optional sub-step (not shown) the host computer provides the user data by executing a host application. In step 1902, the host computer initiates a transmission carrying the user data to the UE. The transmission may pass via the base station, in accordance with the teachings of the embodiments described throughout this disclosure. In step 1904 (which may be optional), the UE receives the user data carried in the transmission.

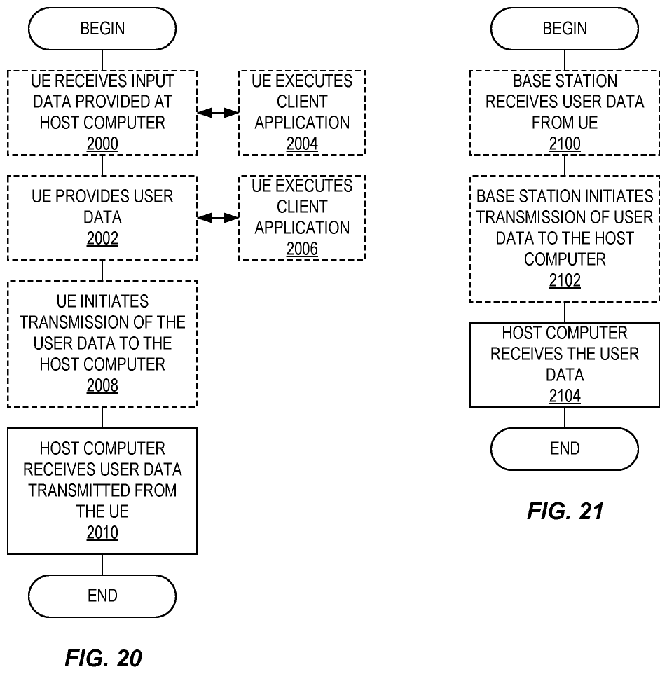

FIG. 20 is a flowchart illustrating a method implemented in a communication system, in accordance with one embodiment. The communication system includes a host computer, a base station, and a UE which may be those described with reference to FIGS. 16 and 17. For simplicity of the present disclosure, only drawing references to FIG. 20 will be included in this section. In step 2000 (which may be optional), the UE receives input data provided by the host computer. Additionally or alternatively, in step 2002, the UE provides user data. In sub-step 2004 (which may be optional) of step 2000, the UE provides the user data by executing a client application. In sub-step 2006 (which may be optional) of step 2002, the UE executes a client application which provides the user data in reaction to the received input data provided by the host computer. In providing the user data, the executed client application may further consider user input received from the user. Regardless of the specific manner in which the user data was provided, the UE initiates, in sub-step 2008 (which may be optional), transmission of the user data to the host computer. In step 2010 of the method, the host computer receives the user data transmitted from the UE, in accordance with the teachings of the embodiments described throughout this disclosure.

FIG. 21 is a flowchart illustrating a method implemented in a communication system, in accordance with one embodiment. The communication system includes a host computer, a base station, and a UE which may be those described with reference to FIGS. 16 and 17. For simplicity of the present disclosure, only drawing references to FIG. 21 will be included in this section. In step 2100 (which may be optional), in accordance with the teachings of the embodiments described throughout this disclosure, the base station receives user data from the UE. In step 2102 (which may be optional), the base station initiates transmission of the received user data to the host computer. In step 2104 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processors (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Those skilled in the art will recognize improvements and modifications to the embodiments of the present disclosure. All such improvements and modifications are considered within the scope of the concepts disclosed herein.

1. A method performed by a network node for a wireless network that utilizes transmit and/or receive beamforming, the method comprising:
dynamically selecting a subset of beams for a particular wireless communication device, the subset of beams being a subset of a set of available beams, wherein dynamically selecting the subset of beams for the particular wireless communication device comprises dynamically selecting which of the set of available beams are included in the subset of beams for the particular wireless communication device and comprises dynamically selecting the subset of beams for the particular wireless communication device based on information that models or represents probabilities that the particular wireless communication device will switch from a current serving beam to each other beam in the set of available beams; and
performing one or more actions based on the selected subset of beams.

2. The method of claim 1 wherein performing the one or more actions comprises:
(a) sending, to the particular wireless communication device, information that indicates the subset of beams;
(b) monitoring for transmissions from the particular wireless communication device on the subset of beams;
(c) performing one or more measurements on the subset of beams at the network node;
(d) receiving measurements about beams in the subset of beams from the particular wireless communication device; or
(e) a combination of any two or more of (a)-(d).

3-6. (canceled)

7. The method of claim 1 wherein the information that models or represents the probabilities that the particular wireless communication device will switch from the current serving beam to the each other beam in the set of available beams is a trained machine learning model that models the probabilities that the particular wireless communication device will switch from the current serving beam to the each other beam in the set of available beams.

8-11. (canceled)

12. The method of claim 1 wherein:
performing the one or more actions comprises receiving, from the particular wireless communication device, one or more measurements for at least one beam in the set of available beams or one or more measurements for at least one beam in the subset of beams; and
the method further comprises evaluating the subset of beams based on the one or more measurements for the at least one beam in the set of available beams or the one or more measurements for the at least one beam in the subset of beams.

13. (canceled)

14. (canceled)

15. The method of claim 12 wherein evaluating the subset of beams comprise evaluating the subset of beams based on the one or more measurements for the at least one beam in the subset of beams, and a machine learning model.

16. The method of claim 15 wherein the machine learning model predicts a best beam for the particular wireless communication device from among the set of available beams based on the one or more measurements for the at least one beam in the subset of beams.

17. The method of claim 12 further comprising:
based on the evaluating, adjusting one or more parameters related to selection of a subset of beams; and
selecting a new subset of beams for the particular wireless communication device based on the one or more adjusted parameters.

18. The method of claim 17 wherein the one or more adjusted parameters comprise a parameter related to a number of beams included in the new subset of beams, a parameter related to a number of beams needed in the subset of beams to satisfy a predefined or configured accuracy related to a mishit of a best beam from the set of available beams for the particular wireless communication device being within the subset of beams, one or more parameters related to a cost to update the subset of beams, a parameter about whether the best beam is included in the subset of beams, a parameter related to whether the best beam is near an edge of the subset of beams, or weightings associated with at least some of the set of available beams that relate to probabilities that those beams are included in the new subset of beams.

19. The method of claim 12 further comprising providing a result of the evaluating to another node for updating of a machine learning model used for beam subset selection.

20. (canceled)

21. (canceled)

22. A network node for a wireless network that utilizes transmit and/or receive beamforming, the network node comprising processing circuitry configured to cause the network node to:
dynamically select a subset of beams for a particular wireless communication device, the subset of beams being a subset of a set of available beams, wherein dynamically selecting the subset of beams for the particular wireless communication device comprises dynamically selecting which of the set of available beams are included in the subset of beams for the particular wireless communication device and comprises dynamically selecting the subset of beams for the particular wireless communication device based on information that models or represents probabilities that the particular wireless communication device will switch from a current serving beam to each other beam in the set of available beams; and
perform one or more actions based on the selected subset of beams.

23. The network node of claim 22 wherein the one or more actions comprise:
(a) sending, to the particular wireless communication device, information that indicates the subset of beams;
(b) monitoring for transmissions from the particular wireless communication device on the subset of beams;
(c) performing one or more measurements on the subset of beams at the network node;
(d) receiving measurements about beams in the subset of beams from the particular wireless communication device; or
(e) a combination of any two or more of (a)-(d).

24. A computer-implemented method comprising:
receiving beam switch related information for a plurality of wireless communication devices;
training a beam switch probability model that models a probability of a beam switch from any first beam in a set of available beams for a wireless network to any second beam in the set of available beams for the wireless network; and
providing the beam switch probability model to a network node in the wireless network.

25. (canceled)

26. A computer-implemented method comprising:
receiving beam measurement information for a plurality of wireless communication devices for a set of available beams in a wireless network;
training a model that predicts a best beam from among the set of available beams for a wireless communication device based on measurements made by the wireless communication device for a subset of the set of available beams; and
providing the model to a network node in the wireless network.

27. (canceled)

28. The network node of claim 22 wherein the information that models or represents the probabilities that the particular wireless communication device will switch from the current serving beam to the each other beam in the set of available beams is a trained machine learning model that models the probabilities that the particular wireless communication device will switch from the current serving beam to the each other beam in the set of available beams.

29. The network node of claim 22 wherein:
the one or more actions comprises receiving, from the particular wireless communication device, one or more measurements for at least one beam in the set of available beams or one or more measurements for at least one beam in the subset of beams; and
the processing circuitry is further configured to cause the network node to evaluate the subset of beams based on the one or more measurements for the at least one beam in the set of available beams or the one or more measurements for the at least one beam in the subset of beams.

30. The network node of claim 29 wherein, in order to evaluate the subset of beams, the processing circuitry is further configured to cause the network node evaluate the subset of beams based on the one or more measurements for the at least one beam in the subset of beams, and a machine learning model.

31. The network node of claim 30 wherein the machine learning model predicts a best beam for the particular wireless communication device from among the set of available beams based on the one or more measurements for the at least one beam in the subset of beams.

32. The network node of claim 29 wherein the processing circuitry is further configured to cause the network node to:
based on the evaluating, adjust one or more parameters related to selection of a subset of beams; and
select a new subset of beams for the particular wireless communication device based on the one or more adjusted parameters.

33. The network node of claim 32 wherein the one or more adjusted parameters comprise a parameter related to a number of beams included in the new subset of beams, a parameter related to a number of beams needed in the subset of beams to satisfy a predefined or configured accuracy related to a mishit of a best beam from the set of available beams for the particular wireless communication device being within the subset of beams, one or more parameters related to a cost to update the subset of beams, a parameter about whether the best beam is included in the subset of beams, a parameter related to whether the best beam is near an edge of the subset of beams, or weightings associated with at least some of the set of available beams that relate to probabilities that those beams are included in the new subset of beams.

34. The network node of claim 29 wherein the processing circuitry is further configured to provide a result of the evaluating to another node for updating of a machine learning model used for beam subset selection.
